(19) United States
(12) Patent Application Publication
(10) Pub. No.: US 2002/0046075 A1
(43) Pub. Date: Apr. 18, 2002

(54) Certificate matching

(76) Inventors: Dipayan Gangopadhyay, San Jose, CA (US); Gary O'Neall, Saratoga, CA (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/904,613

(22) Filed: Jul. 12, 2001

Related U.S. Application Data
(60) Provisional application No. 60/217,538, filed on Jul. 12, 2000.

(51) Int. Cl. G06F 17/60

(52) U.S. Cl. 705/8

(57) ABSTRACT

A method and apparatus for certificate matching is presented. In one embodiment, the invention is a method of matching a candidate to a job. The method includes receiving candidate information related to the candidate in computer readable form. The method further includes receiving job requirements related to the job in computer readable form. The method also includes verifying the candidate information through use of a digital signature and queries transmitted via a network. The method may also include matching the candidate information as verified to the job requirements, and notifying the candidate and a company providing the job of a result of the matching.

### BACKGROUND OF THE INVENTION

1. Field of the Invention

The present invention relates to matching qualified supply to qualified demand and internet information exchange, and specifically relates to matching candidates to jobs through use of Internet protocols.

2. Description of the Related Art

Presently, hiring qualified candidates depends on many manual and error-prone processes. For example, a job may require certain qualifications, but a person reviewing candidate resumes for the job may forget about some of the required qualifications. As a result, an unqualified candidate may be interviewed, thus requiring expenditure of resources to weed out that candidate when such resources may be better utilized elsewhere in an organization. Similarly, candidates may have no interest in a given job, but misunderstand the job description and thus mistakenly apply. Myriad other examples may be detailed (such as candidates lying on resumes for example), however it will be appreciated that the process of hiring a person for a job is necessarily complex. Anything that may simplify that process may be useful.

### SUMMARY OF THE INVENTION

A method and apparatus for certificate matching is presented. In one embodiment, the invention is a method of matching a candidate to a job. The method includes receiving candidate information related to the candidate in computer readable form. The method further includes receiving job requirements related to the job in computer readable form. The method also includes verifying the candidate information through use of a digital signature and queries transmitted via a network. The method may also include matching the candidate information as verified to the job requirements, and notifying the candidate and a company providing the job of a result of the matching.

### BRIEF DESCRIPTION OF THE DRAWINGS

The present invention is illustrated by way of example and not limitation in the accompanying figures.

FIG. 1 illustrates an embodiment of matching a candidate to a job.

FIG. 2 illustrates an embodiment of matching a job to a candidate.

FIG. 3 illustrates an embodiment of matching a set of candidates to a set of jobs.

FIG. 4 illustrates an alternate embodiment of matching a candidate to a job.

FIG. 5 illustrates an embodiment of collecting and verifying candidate information.

FIG. 6 illustrates an embodiment of collecting company information.

### DETAILED DESCRIPTION

A method and apparatus for certificate matching is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

The method and apparatus for certificate matching, in one embodiment, may be used to match candidates to jobs. Candidates have a set of qualifications, such as degrees or training certificates, prior work experience, or willingness to work late shifts. Jobs similarly have a set of requirements, and these requirements may be matched with qualifications from the candidates. Likewise, the qualifications of the candidates may be verified by contacting the institution granting the degree or certificate, the previous employer, or the candidate personally. Once appropriate information is stored in a machine accessible manner, most of the matching and verification may be accomplished through use of internet protocols and software, thus eliminating much manual operation. This is described in more detail in the following description.

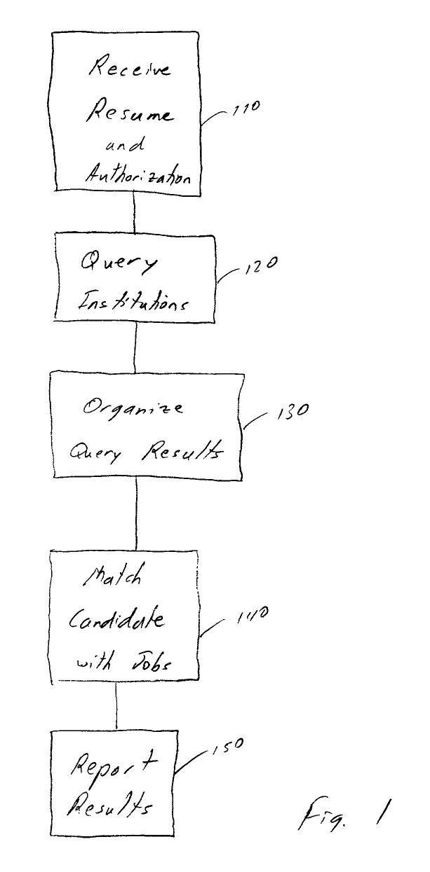

FIG. 1 illustrates an embodiment of matching a candidate to a job. At block 110, a resume is received. It will be appreciated that this may occur as receipt of a resume and data entry into a system. However, it may also involve a candidate providing information about qualifications, experience and preferences to a computer, either through an intermediary or directly. Preferably, the information received at block 110 results in an XML document or set of XML documents that may be easily transferred via the internet or similar network. At block 120, the institutions named by the candidate as providing degrees, certificates, or other training are queried to determine whether the candidate has provided accurate information. Similar queries may be generated for prior jobs and other appropriate information supplied by the candidate. Preferably, these queries occur through the internet or a similar network, and both the requests for information and corresponding responses may be encoded using an X.509 or similar protocol.

At block 130, the query results are organized, thus providing an overall picture of the candidate. If a query resulted in a response indicating no information was available, this may be noted as indicating the candidate supplied the information and it was unverifiable. If the query resulted in a response indicating the information was either correct or wrong, this may be noted appropriately, too. At block 140, the candidate is matched to available jobs. This may include determining whether the candidate has the qualifications for the job, whether the company will accept the level of verification of the candidate's qualifications, and whether the candidate would be interested in the job (based on preferences for example) among other determinations. These determinations may be made by comparing information about the candidate in XML format to information about each job in XML format. At block 150, results of the matching process are reported, thus giving a candidate with multiple potential matches an opportunity to choose which job to pursue first.

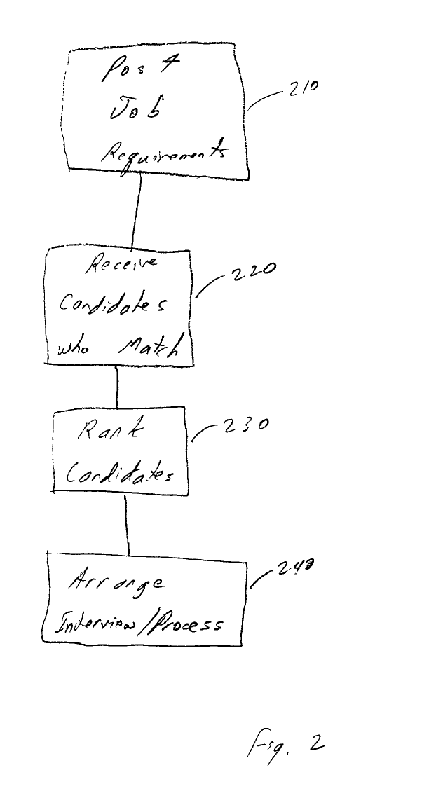

FIG. 2 illustrates an embodiment of matching a job to a candidate. At block 210, job requirements and descriptions are posted. In one embodiment, this may mean a company or organization sends information about a job in XML format to a service which matches candidates to jobs. The service may then match the information provided by the company to candidates who have provided information to the service as discussed above with respect to FIG. 1. At block 220, information about the candidates who matched the job information from block 210 is provided to the company. This information may preferably be transmitted via the internet in XML format.

At block 230, the company may rank the candidates based on various indications of suitability for the job (such as over-qualification or less than desired work experience). At block 240, job interviews may be arranged as appropriate. It will be appreciated that rule-based or other systems may be used to implement the process of block 230, thus eliminating the manual element of the process. Furthermore, interviews as arranged in block 240 may be arranged automatically, by notifying the 5 highest ranked candidates that an interview is requested at a specified date and time, for example.

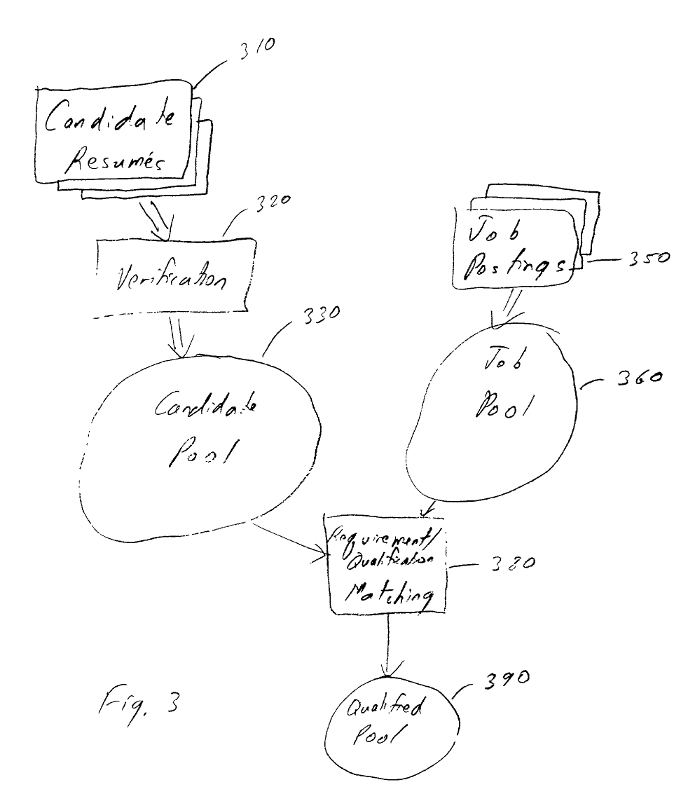

FIG. 3 illustrates an embodiment of matching a set of candidates to a set of jobs. Candidate resumes 310 represent XML-formatted information containing qualifications, preferences and personal information. Verification 320 represents a verification process such as querying institutions or previous employers, and which may be expected to result in various levels of verification for portion of the information provided by each candidate. Candidate pool 330 represents a collection of the candidate resumes 310 as processed by verification 320 and may have further information such as how often a given candidate has interviewed, whether a given candidate's information has expired, and other appropriate information.

Job postings 350 represent XML-formatted job information received from companies (or provided internally within a company to a human resources type of group) and contain job description, requirements and preference information. These job postings 350 are collectively grouped together as job pool 360, which may also contain additional information such as how long a given job posting has existed, how many people have interviewed for a given job, and whether information for a given job posting may have expired (existed long enough to be presumed out of date for example).

Matching block 380 draws information from both candidate pool 330 and job pool 360, and then matches candidates to jobs. This may range anywhere from simply matching requirements to qualifications through matching requirements and verifying that preferences will not block the match, to sophisticated ranking of candidates based on a rich level of detail of information about both the candidate and the job. As illustrated, qualified pool 390 results.

Qualified pool 390 may take on a variety of forms. For a candidate, it may be a pool of jobs that the candidate is qualified for, and may include some form of ranking. For a company or organization, it may be a pool of candidates considered qualified for the company's job(s) with or without ranking. Qualified pool 390 may also be a large integrated database, which is accessible by a candidate to the extent the candidate is qualified for a job and accessible to a company to the extent the company has qualified candidates. It will be appreciated that multiple qualified pools 390 may be produced as appropriate.

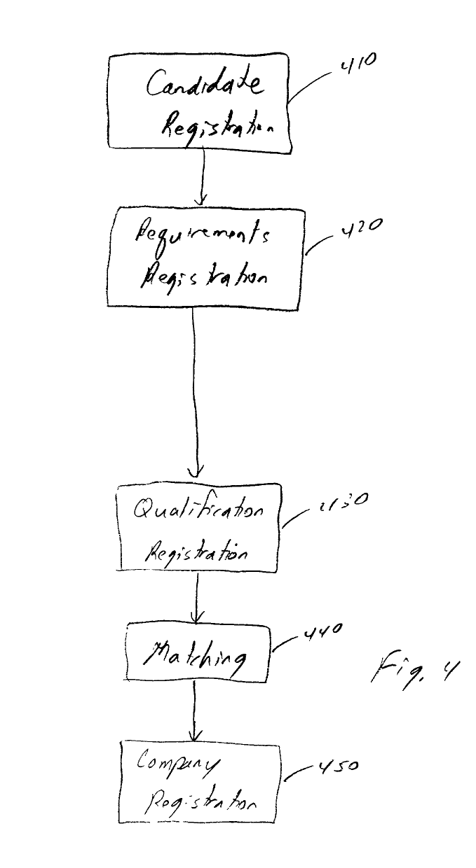

FIG. 4 illustrates an alternate embodiment of matching a candidate to a job. Block 410 includes candidate registration and may include entry of candidate information into a form suitable for processing, such as XML format. Block 420 includes requirements registration and may include entry of company or organization requirements into a form suitable for processing. Block 430 includes qualification registration and may include verification of candidate information through transfer of XML and X.509 encoded information. Block 440 includes matching of candidate information to company requirements, and may include determining whether candidate information is sufficiently verified to satisfy company requirements. Block 450 includes company registration and may include registering the candidate with the company in the event of a match, thus allowing the company to interview or hire the candidate.

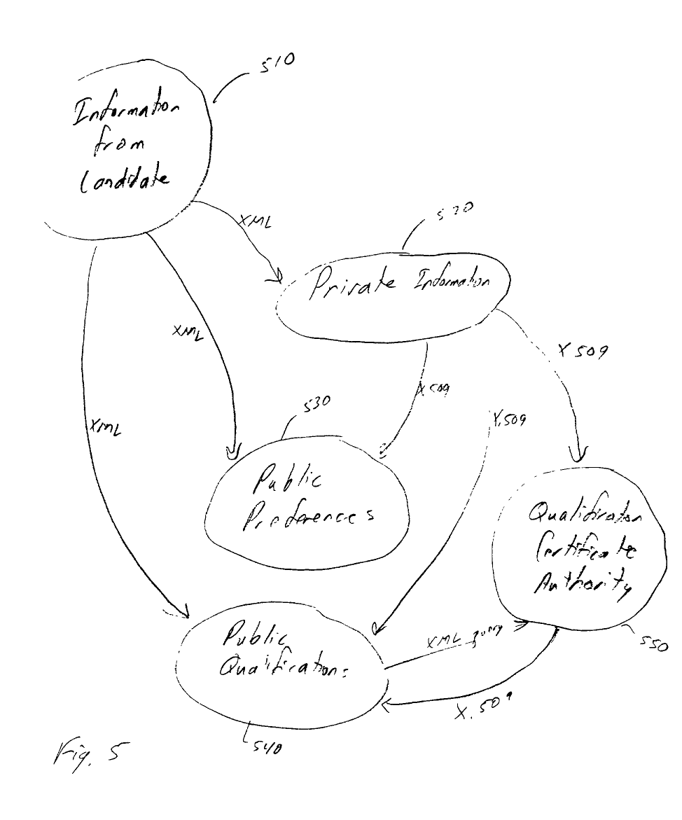

FIG. 5 illustrates an embodiment of information flow in collecting and verifying candidate information. Candidate information 510 is provided in XML format and may be partitioned into three portions in one embodiment. Private information 520 may include a candidate's name and identifying information such as a social security number or other identifying information suitable for use in recruiting or job-hunting. Public preferences 530 may include a candidate's preferences for a job, such as standard work hours, geographical area, field or type of work, among other preference information. Public qualifications 540 may include a candidate's qualifications such as prior work experience, degrees or training certificates, and other qualifications. Note that authority from the candidate to access the public preferences 530 and public qualifications 540 may be required in one embodiment, in which case a digitally signed certificate created and transmitted via X.509 protocols may be used to allow such access.

Public qualifications 540 may further include verification of the candidate's qualifications. A query for verification may be sent out, which in turn may require authority from the candidate for release of the information. That authority may be provided through use of a digital certificate. A candidate may sign the certificate when providing the information, such that the certificate may be encoded through an X.509 protocol from the candidate's private information 520 and transmitted to the qualification certificate authority 550. The qualification certificate authority 550 may then accept the certificate and answer the query with return information encoded through an X.509 protocol, it may reject the certificate and refuse to provide information, or it may indicate that no information is available.

The candidate information 510 may have an expiration date imposed by either the candidate or whatever service receives the information. This expiration date may be imposed by the candidate to prevent continuous and open-ended access to the candidate's information for example. Likewise, the expiration date may be imposed by the service to prevent cluttering of the service's storage devices with stale data.

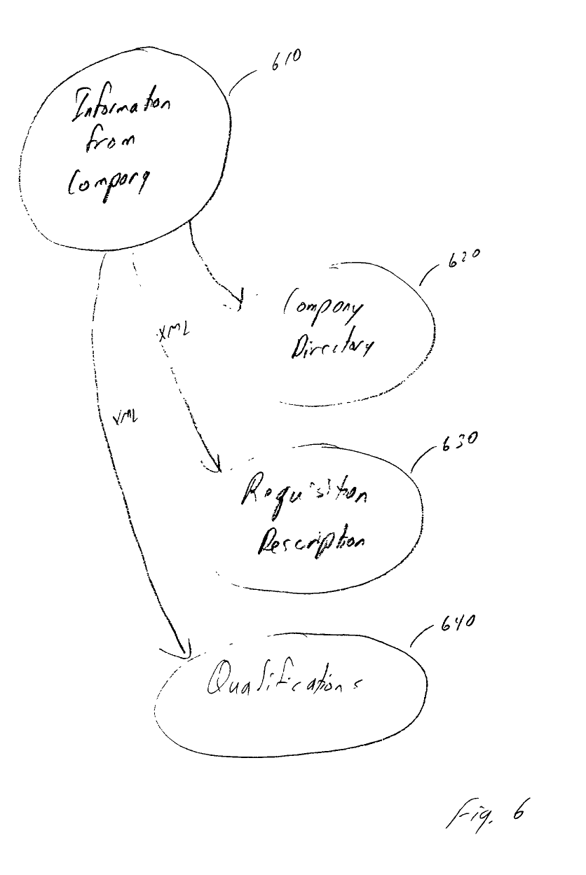

FIG. 6 illustrates an embodiment of collecting company information. Company provided information 610 may include general company information and job-specific information and requirements. Company directory 620 may simply be a repository for the company information 610 and may also include information about interactions between the company and any services providing candidates or between the company and past candidates. Requisition description 630 may be the XML description of the job the company seeks to fill, and it will be appreciated that multiple requisition descriptions 630 may exist for a single company. Similarly, qualifications 640 may be the XML description of the requirements for the job the company seeks to fill, and it will be appreciated that multiple requisition descriptions 630 may exist for a single company. One may anticipate that there will be a one-to-one correspondence between qualifications 640 and requisition descriptions 630 in one embodiment. However, in alternate embodiments, qualifications 640 may apply to a range of jobs, each having a separate requisition description 630 due to different job locations for example

In the foregoing detailed description, the method and apparatus of the present invention has been described with reference to specific exemplary embodiments thereof. It will, however, be evident that various modifications and changes may be made thereto without departing from the broader spirit and scope of the present invention. In particular, the separate blocks of the various block diagrams represent functional blocks of methods or apparatuses and are not necessarily indicative of physical or logical separations or of an order of operation inherent in the spirit and scope of the present invention. For example, the various blocks of FIG. 3 may be integrated into components, or may be subdivided into components. Moreover, the blocks of FIG. 4 represent portions of a method which, in some embodiments, may be reordered or may be organized in parallel rather than in a linear or step-wise fashion. The present specification and figures are accordingly to be regarded as illustrative rather than restrictive.

### APPENDIX B

Title 37, Code of Federal Regulations, Section 1.56 Duty to Disclose Information Material to Patentabilitv

(a) A patent by its very nature is affected with a public interest. The public interest is best served, and the most effective patent examination occurs when, at the time an application is being examined, the Office is aware of and evaluates the teachings of all information material to patentability. Each individual associated with the filing and prosecution of a patent application has a duty of candor and good faith in dealing with the Office, which includes a duty to disclose to the Office all information known to that individual to be material to patentability as defined in this section. The duty to disclose information exists with respect to each pending claim until the claim is cancelled or withdrawn from consideration, or the application becomes abandoned. Information material to the patentability of a claim that is cancelled or withdrawn from consideration need not be submitted if the information is not material to the patentability of any claim remaining under consideration in the application. There is no duty to submit information which is not material to the patentability of any existing claim. The duty to disclose all information known to be material to patentability is deemed to be satisfied if all information known to be material to patentability of any claim issued in a patent was cited by the Office or submitted to the Office in the manner prescribed by §§ 1.97(b)-(d) and 1.98. However, no patent will be granted on an application in connection with which fraud on the Office was practiced or attempted or the duty of disclosure was violated through bad faith or intentional misconduct. The Office encourages applicants to carefully examine:

(1) Prior art cited in search reports of a foreign patent office in a counterpart application, and

(2) The closest information over which individuals associated with the filing or prosecution of a patent application believe any pending claim patentably defines, to make sure that any material information contained therein is disclosed to the Office.

(b) Under this section, information is material to patentability when it is not cumulative to information already of record or being made of record in the application, and

(1) It establishes, by itself or in combination with other information, a prima facie case of unpatentability of a claim; or

(2) It refutes, or is inconsistent with, a position the applicant takes in:

(i) Opposing an argument of unpatentability relied on by the Office, or

(ii) Asserting an argument of patentability.

A prima facie case of unpatentability is established when the information compels a conclusion that a claim is unpatentable under the preponderance of evidence, burdenof-proof standard, giving each term in the claim its broadest reasonable construction consistent with the specification, and before any consideration is given to evidence which may be submitted in an attempt to establish a contrary conclusion of patentability.

(c) Individuals associated with the filing or prosecution of a patent application within the meaning of this section are:

(1) Each inventor named in the application;

(2) Each attorney or agent who prepares or prosecutes the application; and

(3) Every other person who is substantively involved in the preparation or prosecution of the application and who is associated with the inventor, with the assignee or with anyone to whom there is an obligation to assign the application.

(d) Individuals other than the attorney, agent or inventor may comply with this section by disclosing information to the attorney, agent, or inventor.

(e) In any continuation-in-part application, the duty under this section includes the duty to disclose to the Office all information known to the person to be material to patentability, as defined in paragraph (b) of this section, which became available between the filing date of the prior application and the national or PCT international filing date of the continuation-in-part application.

### APPENDIX A

William E. Alford, Reg. No. 37,764; Farzad E. Amini, Reg. No. 42,261; William Thomas Babbitt, Reg. No. 39,591; Carol F. Barry, Reg. No. 41,600; Jordan Michael Becker, Reg. No. 39,602; Lisa N. Benado, Reg. No. 39,995; Bradley J. Bereznak, Reg. No. 33,474; Michael A. Bernadicou, Reg. No. 35,934; Roger W. Blakely, Jr., Reg. No. 25,831; R. Alan Burnett, Reg. No. 46,149; Gregory D. Caldwell, Reg. No. 39,926; Thomas M. Coester, Reg. No. 39,637; Donna Jo Coningsby, Reg. No. 41,684; Florin Corie, Reg. No. 46,244; Mimi Diemmy Dao, Reg. No. 45,628; Dennis M. deGuzman, Reg. No. 41,702; Stephen M. De Klerk, Reg. No. 46,503; Michael Anthony DeSanctis, Reg. No. 39,957; Daniel M. De Vos, Reg. No. 37,813; Justin M. Dillon, Reg. No. 42,486; Sanjeet Dutta, Reg. No. 46,145; Matthew C. Fagan, Reg. No. 37,542; Tarek N. Fahmi, Reg. No. 41,402; Thomas S. Ferrill, Reg. No. 42,532; George Fountain, Reg. No. 37,374; James Y. Go, Reg. No. 40,621; James A. Henry, Reg. No. 41,064; Libby N. Ho, Reg. No. 46,774; Willmore F. Holbrow III, Reg. No. 41,845; Sheryl Sue Holloway, Reg. No. 37,850; George W Hoover II, Reg. No. 32,992; Eric S. Hyman, Reg. No. 30,139; William W. Kidd, Reg. No. 31,772; Sang Hui Kim, Reg. No. 40,450; Walter T. Kim, Reg. No. 42,731; Eric T. King, Reg. No. 44,188; George Brian Leavell, Reg. No. 45,436; Kurt P. Leyendecker, Reg. No. 42,799; Gordon R. Lindeen III, Reg. No. 33,192; Jan Carol Little, Reg. No. 41,181; Robert G. Litts, Reg. No. 46,876; Julio Loza, Reg. No. P47,758; Joseph Lutz, Reg. No. 43,765; Michael J. Mallie, Reg. No. 36,591; Andre L. Marais, Reg. No. P048,095; Paul A. Mendonsa, Reg. No. 42,879; Clive D. Menezes, Reg. No. 45,493; Chun M. Ng, Reg. No. 36,878; Thien T. Nguyen, Reg. No. 43,835; Thinh V. Nguyen, Reg. No. 42,034; Robert B. O'Rourke, Reg. No. 46,972; Daniel E. Ovanezian, Reg. No. 41,236; Kenneth B. Paley, Reg. No. 38,989; Gregg A. Peacock, Reg. No. 45,001; Marina Portnova, Reg. No. 45,750; William F. Ryann, Reg. 44,313; James H. Salter, Reg. No. 35,668; William W. Schaal, Reg. No. 39,018; James C. Scheller, Reg. No. 31,195; Jeffrey S. Schubert, Reg. No. 43,098; George Simion, Reg. No. P47,089; Maria McCormack Sobrino, Reg. No. 31,639; Stanley W. Sokoloff, Reg. No. 25,128; Judith A. Szepesi, Reg. No. 39,393; Edwin H. Taylor, Reg. No. 25,129; John F. Travis, Reg. No. 43,203; Joseph A. Twarowski, Reg. No. 42,191; Mark C. Van Ness, Reg. No. 39,865; Tom Van Zandt, Reg. No. 43,219; Brent E. Vecchia, Reg. No. P48,011; Lester J. Vincent, Reg. No. 31,460; Archana B. Vittal, Reg. No. 45,182; Glenn E. Von Tersch, Reg. No. 41,364; John Patrick Ward, Reg. No. 40,216; Mark L. Watson, Reg. No. 46,322; Thomas C. Webster, Reg. No. 46,154; and Norman Zafman, Reg. No. 26,250; my patent attorneys, and Firasat Ali, Reg. No. 45,715; and Raul Martinez, Reg. No. 46,904, my patent agents, of BLAKELY, SOKOLOFF, TAYLOR & ZAFMAN LLP, with offices located at 12400 Wilshire Boulevard, 7th Floor, Los Angeles, Calif. 90025, telephone (310) 207-3800, and James R. Thein, Reg. No. 31,710, my patent attorney with full power of substitution and revocation, to prosecute this application and to transact all business in the Patent and Trademark Office connected herewith.

What is claimed is:

1. A method of matching a candidate to a job comprising:
receiving candidate information related to the candidate in computer readable form;
receiving job requirements related to the job in computer readable form;
verifying the candidate information through use of a digital signature and queries transmitted via a network;
matching the candidate information as verified to the job requirements; and
notifying the candidate and a company providing the job of a result of the matching.

2. The method of claim 1 wherein:
candidate information includes qualifications and preferences.

3. The method of claim 1 wherein:
job requirements further includes a job description.

4. The method of claim 1 wherein:
candidate information includes qualifications and preferences; and
job requirements further includes a job description.

5. The method of claim 4 further comprising:
matching the preferences to the job description and notifying further includes notifying of the result of matching the preferences to the job description.

6. The method of claim 5 wherein:
verifying includes encoding the digital signature and queries for transmission through an X.509 protocol;
and further comprising:
receiving verification responses as a result of transmitting the queries, the verification responses also encoded for transmission through an X.509 protocol and the verification responses also transmitted via the network.

7. A method of matching a set of candidates to a set of jobs
receiving candidate information related to each candidate of the set of candidates in computer readable form;
receiving job requirements related to each job of the set of jobs from a job provider in computer readable form;
verifying the candidate information of each candidate through use of a digital signature of the candidate information and queries transmitted via a network;
matching the candidate information as verified of each candidate of the set of candidates to the job requirements of the jobs of the set of jobs;
notifying each candidate of results of the matching; and
notifying each job provider of results of the matching.

8. The method of claim 7 wherein:
candidate information includes qualifications and preferences; and
job requirements further includes a job description.

9. The method of claim 8 further comprising:
matching the preferences to the job description and each notifying further includes notifying of the result of matching the preferences to the job description.

10. The method of claim 9 wherein:
results of the matching includes rankings of the jobs of the set of jobs with respect to each candidate and rankings of the candidates of the set of candidates with respect to each job.

11. A machine readable medium embodying instructions suitable for execution by a processor, the processor when executing the instructions performing a method, the method comprising:
receiving candidate information related to each candidate of a set of candidates in computer readable form;
receiving job requirements related to each job of a set of jobs from a job provider in computer readable form;
verifying the candidate information of each candidate through use of a digital signature of the candidate information and queries transmitted via a network;
matching the candidate information as verified of each candidate of the set of candidates to the job requirements of the jobs of the set of jobs;
notifying each candidate of results of the matching; and
notifying each job provider of results of the matching.

12. The machine readable medium of claim 11 further embodying instructions suitable for execution by a processor, the processor when executing the instructions performing a method, the method wherein:
candidate information includes qualifications and preferences;
job requirements further includes a job description;
and further comprising:
matching the preferences to the job description and each notifying further includes notifying of the result of matching the preferences to the job description.

13. The machine readable medium of claim 12 further embodying instructions suitable for execution by a processor, the processor when executing the instructions performing a method, the method wherein:
results of the matching includes rankings of the jobs of the set of jobs with respect to each candidate and rankings of the candidates of the set of candidates with respect to each job.

14. The machine readable medium of claim 12 further embodying instructions suitable for execution by a processor, the processor when executing the instructions performing a method, the method wherein:
verifying includes encoding the digital signature and queries for transmission through an X.509 protocol;
and further comprising:
receiving verification responses as a result of transmitting the queries, the verification responses also encoded for transmission through an X.509 protocol and the verification responses also transmitted via the network.
